(19) United States
(12) Patent Application Publication
(10) Pub. No.: US 2017/0322059 A1
(43) Pub. Date: Nov. 9, 2017

(54) LOW PRESSURE DROP AND HIGH TEMPERATURE FLOW MEASURING DEVICE

(71) Applicant: Eric Lowe, Chapel Hill, NC (US)

(72) Inventor: Eric Lowe, Chapel Hill, NC (US)

(21) Appl. No.: 15/149,446

(22) Filed: May 9, 2016

(51) Int. Cl. G01F 1/34; G01F 15/14

(52) U.S. Cl. CPC G01F 1/34; G01F 15/14

(57) ABSTRACT

A flow measuring device for monitoring and measuring the flow of gaseous material, specifically high temperature gas using a low pressure drop measurement system, is provided. The device is adapted to fit within the pipeline of a flow system and may be installed wherever flow measurement is needed. In one embodiment, the device comprises a housing, multiple averaging pitot tubes to determine the total velocity and static pressure measurements, a differential pressure gauge to display the pressure, and a valve or valves to cut off flow as needed. Additionally, the present invention utilizes a means for cooling the temperature of the gas, thus negating the need for very expensive gauges capable of operating under very high temperatures. Overall, the flow measuring device herein provides a more efficient and cost-effective product and method to measure the flow of a liquid or gas, specifically a high temperature gas.

### BACKGROUND OF THE INVENTION

Flow meters are an integral tool for measuring the flow of liquid, gas, or a mixture of both, for applications used in the food and beverage industry, oil and gas plants, and chemical/pharmaceutical factories. Fluid characteristics (single or double phase, viscosity, turbidity, etc.), flow profile (laminar, transitional, or turbulent, etc.), flow range, and the need for accurate measurements are key factors for determining the right flow meter for a particular application. Additional considerations such as mechanical restrictions and output-connectivity options also impact this choice. The overall accuracy of a flow meter depends to some extent on the circumstances of the application. The effects of pressure, temperature, fluid, and dynamic influences can potentially alter the measurement being taken.

Presently, most known systems where a fluid or gas flows at a constant rate require a separate flow measurement device to verify the system flow rate. Differential pressure flow meters measure the differential pressure drop across a constriction in the flow's path to infer the flow velocity. Common types of differential-pressure flow meters are the orifice plate, the pitot tube, and the venturi tube. Orifice plates are widely used to measure the flow rate in a pipeline in order to monitor and control the flow rate, efficiency and effectiveness of the process, refinery, or equipment utilizing the pipeline. Orifice plates are usually mounted between orifice flanges and one or more seals or gaskets and installed between similar size pipes. Orifice plates customarily have a constricted opening that is smaller than the adjacent pipes to which they are attached in order to increase the flow and velocity of the fluid or gas as it passes through the orifice plate. As the fluid or gas flows through the hole in the orifice plate, in accordance with the law of conservation of mass, the velocity of the flow that leaves the orifice is more than the velocity of the flow as it approaches the orifice. By Bernoulli's principle, this means that the pressure on the inlet side is higher than the pressure on the outlet side. Measuring this differential pressure gives a direct measure of the flow velocity from which the flow rate can easily be calculated.

There are disadvantages to using orifice plates. The differential pressure measured by orifice plates result in a pressure drop from one side of the plate to the other as the flow travels through the orifice. This relative pressure drop is typically high. This high drop in pressure requires more energy to be used by the system in order to propel the flow of fluid or gas at a sufficient velocity through tubing or pipelines despite this drop in pressure. As a result, a need for more energy is required to maintain operation throughout the overall system. For example, motors of sufficient horsepower are needed to power fans, blowers, and any other equipment used to run all the different components of a given application. A higher energy requirement results in a less efficient system and increases operating costs of the overall application.

A common application for the use of flow meters is combined cycle power plants. A combined-cycle power plant uses both a gas and a steam turbine together to produce up to 50 percent more electricity from the same fuel than a traditional simple-cycle plant. The waste heat from the gas turbine is routed to the nearby steam turbine, which generates extra power. At least some known electric power generating facilities include combined cycle power plants that include one or more gas turbines, at least one heat recovery steam generator (HRSG), and at least one steam turbine. The gas turbine compresses air and mixes it with fuel that is heated to a very high temperature. The hot air-fuel mixture moves through the gas turbine blades, making them spin, and the fast-spinning turbine drives a generator that converts a portion of the spinning energy into electricity. The HRSG captures exhaust heat from the gas turbine that would otherwise escape through the exhaust stack. The HRSG creates steam from the gas turbine exhaust heat and delivers it to the steam turbine, and the steam turbine sends its energy to the generator drive shaft, where it is converted into additional electricity. The HRSG and the steam turbine are coupled in flow communication through steam piping. The gas turbines and the HRSG are coupled in flow communication through combustion gas ducts. A combustion exhaust gas stream including waste heat generated by the gas turbines is channeled to the HRSG to generate steam through the combustion gas ducts. The steam is channeled to the steam turbines to generate power. i.e., typically electric power.

Differential pressure flow meters, more specifically orifice plates, are commonly used on HRSGs to measure the flow rate of the gases moving through the system. However, these orifice plates suffer the aforementioned disadvantage of being inefficient and contribute to expensive operating costs. Additionally, because the gases that travel though the HRSG are extremely hot, special pressure gauges that are capable of withstanding these extremely high temperatures are needed to measure the flow rate, and these types of gauges are very expensive.

In light of the disadvantages of flow meters commonly used in the art, it would be advantageous to provide a flow measuring device that results in a lower pressure drop but is still capable of providing an accurate flow measurement of high temperature gases. A device such as this would be more efficient, more economical, and would have a smaller environmental footprint.

### BRIEF SUMMARY OF THE INVENTION

The present invention is a flow station or flow measuring device for monitoring and measuring the flow of gaseous material, specifically high temperature gas using a low pressure drop measurement system. More specifically, this invention provides accurate, repeatable measurement of air movement through ducts and piping for high temperature air and air with low concentrations of certain gases.

The flow measuring device of the present invention utilizes Bernoulli's principle to measure a differential pressure drop to give a direct measure of the flow velocity from which the volumetric flow can easily be calculated. The device is adapted to fit within the pipeline of a flow system and may be installed wherever flow measurement is needed. In one embodiment, the device comprises a housing or pipe that includes a flow detector (i.e. pressure sensing flow measuring tubes) to detect the flow of gas, a differential pressure gauge to display the pressure, and a valve or valves to cut off flow as needed. Additionally, the present invention utilizes a means for cooling the temperature of the gas, i.e. gauge coolers, to help dissipate heat from the hot gas prior to reaching the gauge, thus negating the need for very expensive gauges capable of operating under very high temperatures.

In one aspect, the present invention uses multiple averaging pitot tubes to determine the total velocity and static pressure measurements. The flow of gas enters the device at an upstream end, this end preferably including a flow straightener, and then passes through the flow measuring tubes. The tubes are placed across the flow stream according to standards for equal-area averaging. Rather than using traditional orifice plates, which are most commonly used in the industry to measure differential pressure, the present invention uses Fechheimer Pitot flow measurement principles by drilling Pitot sensor tubes according to Fechheimer probe standards and then affixing these tubes into the housing according to the Pitot traverse standards for equal-area averaging. This arrangement results in a much lower pressure drop needed to measure flow as compared to typical orifice plates. As the flow is detected and measured, the pressure is displayed and monitored by the gauge(s). Valves may be used to adjust the pressure as needed to ensure an even flow distribution as well as to cut off flow completely for maintenance and repairs. Overall, the flow measuring device herein provides a more efficient and cost-effective product and method to measure the flow of a liquid or gas, specifically a high temperature gas.

### DESCRIPTION OF THE DRAWINGS

These and other features, aspects, and advantages of the present invention will become better understood with regard to the following description, appended claims, and accompanying drawings where:

FIG. 1 is a perspective view of one embodiment of a flow measuring device of the present invention;

FIG. 2 is a side view of one embodiment of a flow measuring device of the present invention;

FIG. 3 is a front view of one embodiment of a flow measuring device of the present invention showing the upstream end of the device where the flow of gas will enter the device; and

FIG. 4 illustrates a Heat Recovery Steam Generator (HRSG), showing one embodiment of the present invention installed on an ammonia injection grid of a HRSG to monitor the flow of ammoniated gas.

### DETAILED DESCRIPTION OF THE INVENTION

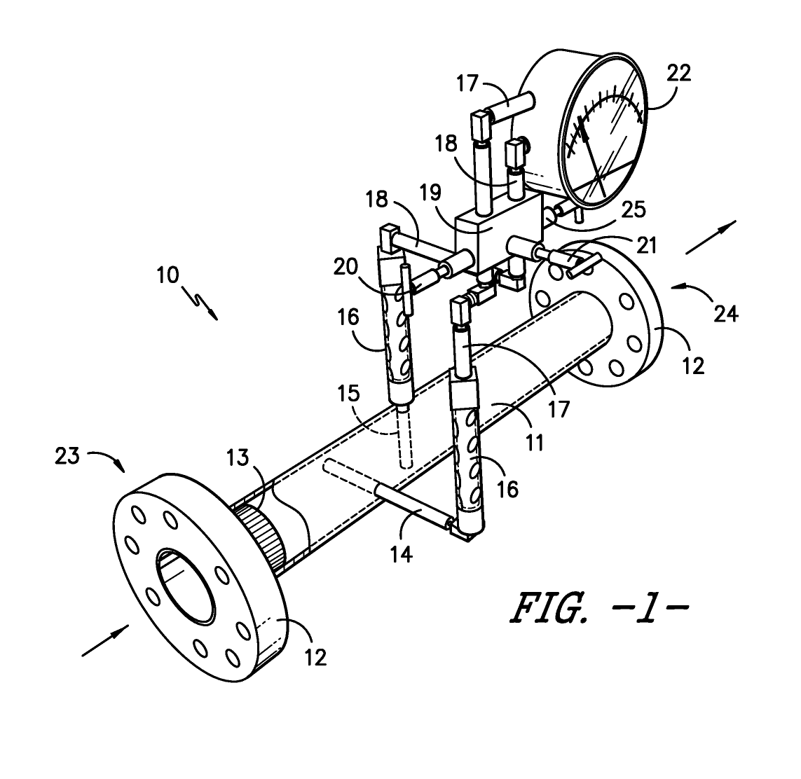

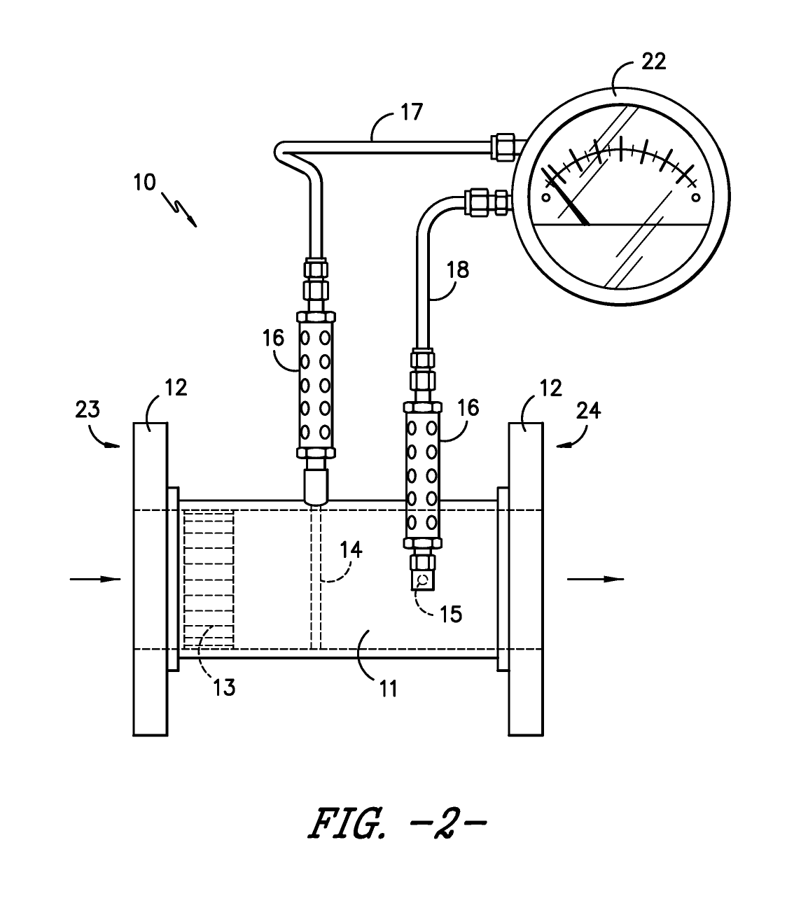

FIGS. 1 and 2 illustrate a perspective and side view (respectively) of the flow measuring device 10 of the present invention. In a preferred embodiment, the device 10 is comprised of a housing 11, such as a pipe, with a flange 12 affixed to an upstream 23 and downstream end 24. The upstream end 23 of the device 10 preferably includes a flow straightener 13 to help eliminate any flow distortion effects as the gas flow enters the device 10. As the gas enters, it flows through the straightener 13 and over/through the first and second flow measuring tubes 14, 15, or pressure sensing pitot tubes. The first tube 14 measures total pressure, whereas the second tube 15 measures static pressure. The differential pressures detected by each tube 14, 15 are measured, and the resulting velocity pressure is calculated by subtracting the static pressure detected by the second tube 15 from the total pressure detected by the first tube 14. The resulting velocity pressure is indicative of the flow rate. Pressure ports 17, 18 connect the flow measuring tubes 14, 15 to the differential pressure gauge 22, and the gauge 22 then displays the resulting velocity pressure. The device 10 preferably includes a means for cooling the temperature 16 of the flow to help dissipate heat from the gas prior to reaching the gauge 22. A gauge manifold 19 may be employed to provide valves 20, 21 to adjust or shut off the flow of gas from either the high pressure port 17, low pressure port 18, or both ports for service and repairs. Valves such as butterfly valves may also be utilized to adjust the flow of gas throughout the system.

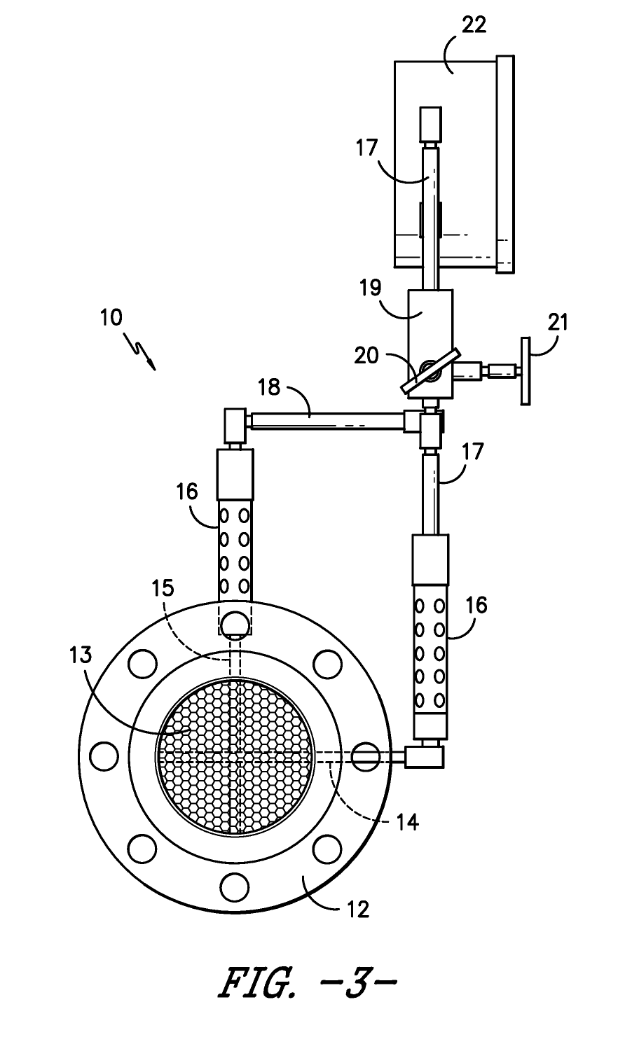

Referring to the Figures in more detail, FIGS. 1 and 3 illustrate one embodiment of the upstream end 23 of the flow measuring device 10 where the flow of gas enters the device 10. The main housing 11, or pipe, is preferably constructed to comply with ANSI standard B31.3 and may be made of a material such as stainless steel, but may also be carbon steel or another suitable material capable of withstanding harsh conditions such as very high temperatures, high pressures, cycling between hot and cold, and exposure to abrasive elements. In a preferred embodiment, flanges 12 are welded to each end of the housing 11, and a flow straightener 13, such as a honeycomb straightener, is affixed within the upstream end 23 of the pipe 11, as shown in FIG. 3. The dimensions of the main housing 11 depend upon the dimensions and shape of the pipeline of the flow system and the given application of use, however, the diameter is preferably within the range of 2.5 to 12 inches. The length of the device 10 is preferably a minimum of 24 inches so that the gas flow has adequate length to straighten, thus allowing for accurate flow measurement by the measuring tubes 14, 15 and gauge(s) 22. Additionally, the shape of the housing 11 may be round, rectangular, oval, or another suitable shape for the adapting to the overall flow system.

Referring to FIGS. 1-3, a total pressure sensing tube 14 (first tube) and a static pressure sensing tube 15 (second tube) are affixed traversing the interior cross sectional area of the housing 11. The sensor tubes 14, 15 may be welded through holes drilled or cut in the housing 11, such that one end of each tube 14, 15 is flush with the inside of the pipe 11, and the other end of each tube 14, 15 protrudes outward from the housing 11 for attachment of the gauge coolers 16 and the pressure ports 17, 18. The length and diameter of the pressure sensing tubes 14, 15 are dependent upon the size of the flow measuring device 10.

The tubes 14, 15 are positioned within the housing 11 and relative to one another according to the Pitot standard traverse to accurately measure the differential pressure. The total pressure sensing pitot tube 14 is affixed traversing the interior cross sectional area of the device 10 for sensing the total pressure of gas flowing into the device 10. The static pressure sensing pitot tube 15 is also affixed traversing the interior cross sectional area of the device 10 for sensing the average static pressure within the flow measuring device 10. By positioning the total pressure tube 14 within the housing 10 upstream relative to the static pressure tube 15, pitot tube flow principles are thereby utilized by sensing the total pressure of the flowing gas or air with the total pressure sensing pitot tube 14, and the static pressure within the pipeline or conduit is sensed by the static pressure sensing pitot tube 15.

In one preferred embodiment illustrated by FIG. 1, the tubes 14, 15 are positioned perpendicular to one another such that the total pressure sensing tube 14 lies horizontal and the static pressure sensing tube 15 is vertical. However, the tubes 14, 15 may lie parallel to one another whereby both tubes are positioned horizontally or both tubes are positioned vertically. The directional positioning of the tubes 14, 15 depends mainly upon how the remainder of the flow station components (i.e. gauges 22, gauge coolers 16, gauge manifold 19, etc.) are positioned to fit within space confinements of any given application.

Each flow measuring tube 14, 15 has at least one hole or sensing port penetrating each tube. The sensing ports for the total pressure are located on the leading edge of the total pressure sensing tube 14, while static pressure ports penetrate the side of the static pressure sensing tube 15. The total number and location of sensing ports are positioned in accordance with Fechheimer standards, such that the first total pressure tube 14 has a hole (or holes) in the direction of airflow to measure total pressure, and the second static pressure tube 15 has a hole (or holes) drilled off-center at a point of zero velocity in order to measure static pressure. The number of holes drilled in each flow measuring tube 14, 15 is dependent upon the size of the tube, for example a larger tube may necessitate more than one hole. From these two measurements (total pressure and static pressure), velocity pressure and flow rate can be determined by subtracting the static pressure from the total pressure. The differential pressure drop that occurs in this device 10 is less than 1.5 inches w.c., which is much less than the typical pressure drop of 10-15 inches w.c occurring in other differential pressure measuring systems. This low pressure drop increases the efficiency of the system and reduces operating costs.

In a preferred embodiment, a means for cooling the temperature of the flow 16, such as gauge coolers, are coupled to the protruding ends of each flow measuring pitot tube 14, 15, as shown in FIGS. 1-3. The gauge coolers may be mounted above a diaphragm seal, pigtail siphon, or threaded directly into the tube 14, 15. In a preferred embodiment, a threaded coupling mounts the gauge coolers 16 onto the tubes 14, 15. The threaded portion is preferably insulated with Teflon tape or another suitable insulating material to protect from hot gases traveling through the conduit and device 10. The gauge cooler 16 is preferably a stainless steel tube with a stainless steel perforated sleeve that allows for the dissipation of heat from the hot gas as it travels through the cooling device 16.

The gauge coolers 16 may be connected to the pressure gauge 22 through pressure ports 17, 18. In one embodiment, a high pressure port 17 is connected to the gauge cooler 16 that is coupled to the total pressure sensing tube 14; and, a low pressure port 18 is connected to the gauge cooler 16 that is coupled to the static pressure sensing tube 15. Each port 17, 18 may then be connected directly to the pressure gauge 22, as in FIG. 2. The pressure ports 17, 18 may be connected to the gauge 22 and gauge coolers 16 through threaded couplings or any other suitable method. In an alternative embodiment, the pressure ports 17, 18 may be connected from the gauge coolers 16 to a gauge manifold 19, with additional pressure ports 17, 18 continuing from the gauge manifold 19 for connection to the pressure gauge 22, as seen in FIGS. 1 and 3. In a preferred embodiment, the gauge manifold 19 is a 3-valve block manifold 19 that includes three valves 20, 21, 25: a first valve 20 for controlling the high pressure port 17 connected to the total pressure flow measuring tube 14 (the first tube), a second valve 25 for controlling the low pressure port 18 connected to the static pressure flow measuring tube 15 (the second tube), and a third valve 21 for controlling both the high and low pressure ports 17, 18 simultaneously. These valves 20, 21, 25 allow for one or both pressure ports 17, 18 to be turned off as needed for maintenance, repairs, and replacement of parts.

The pressure gauge 22 may be any differential pressure gauge 22 for indicating flow rate and/or for transmitting a flow rate signal. In a preferred embodiment, the gauge 22 has a high pressure connection for a high pressure port 17 and a low pressure connection for a low pressure port 18. As described above, the gauge 22 may be connected to the flow measuring tubes 14, 15 through the high and low pressure ports 17, 18 such that accurate pressure measurement may be obtained. If the gauge 22 needs to be serviced or maintained, flow to the gauge 22 may be cut off via the valves 20, 21, 25.

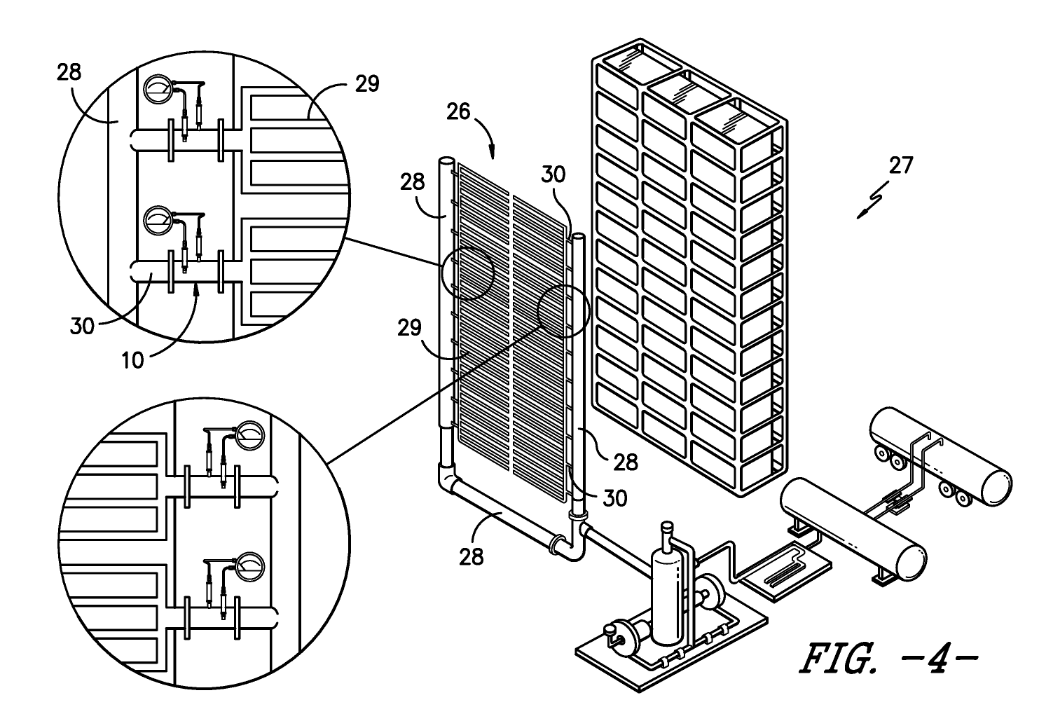

The flow measuring device 10 described herein may be used in any application where flow measurement or monitoring is needed. To give greater frame of reference, an exemplary embodiment of the flow measuring device 10 is described in the context of use on an ammonia grid 26 of a Heat Recovery Steam Generator (HRSG), as shown in FIG. 4, to monitor the flow of ammoniated flue gas to each zone of the ammonia injection grid 26 to ensure an even distribution of gas to the HRSG.

Many known HRSGs include a selective catalytic reduction (SCR) system 27 for removing regulated combustion products, e.g., nitrogen oxides (NOₓ) from the combustion exhaust gas stream prior to exhausting the gases to the atmosphere through an exhaust stack. A reductant, such as ammonia (NH₃), is injected into the exhaust gas stream entering the SCR system 27 to facilitate further removal of NOₓ from the exhaust gas prior to entering the stack and then the atmosphere. The NH3 injection flow rate is regulated to maintain measured NOx close to a predetermined stack NOx setpoint. Such regulation is accomplished fairly easily during steady-state operation of the combined cycle power system by establishing a substantially constant NH3 injection flow rate setpoint and regulating the flow to that setpoint.

It is contemplated that the flow measuring device 10 of the present invention may be installed on the pipelines of the ammonia injection grid 26 to monitor the flow of ammoniated flue gas. As the vaporized ammonia is mixed with the HRSG exhaust gas, the gas mixture travels through the manifold 28 of the to the ammonia injection grid 26 where it may enter segments 29 of the ammonia injection grid 26 via injection ports 30. As shown in the circular insets of FIG. 4, the flow measuring device 10 may be installed on the injection ports 30 such that the gas mixture enters the upstream end 23 of the flow measuring device 10, flowing first through the flow straightener 13. The flow straightener 13 reduces flow distortions and helps ensure an accurate pressure reading from the pressure sensing tubes 14, 15. The ammoniated gas may then flow through the total pressure sensing tube 14 and the static pressure sensing tube 15, whereby total and static pressure may be measured. The gas flow may be cooled through the use of a cooling mechanism 16 such as a gauge cooler, so that the temperature of the gas is decreased prior to reaching the differential pressure gauge 22. The differential pressure gauge 22 may be operably connected to the pressure sensing tubes 14, 15 so that the velocity pressure and flow rate may be communicated to the gauge 22 and displayed by the gauge 22. If the flow rate of ammoniated gas to one or more zones or segments 29 of the ammonia injection grid 26 differs from the predetermined setpoint, valves may be employed to adjust the flow of the gas until it reaches the desired setpoint. Furthermore, valves may also be used to cut off gas flow completely in the event that shutoff is necessary.

Although the flow measuring device 10 of the present invention has been described in detail with reference to particular embodiments and dimensions, the embodiments are for illustrative purposes only and do not limit the invention. It is to be appreciated that those skilled in the art can change or modify the embodiments without departing from the scope and spirit of the invention. It is to be understood that the inventive concept is not to be considered limited to the constructions and dimensions disclosed herein.

The terms used in the present application are merely used to describe particular embodiments, and are not intended to limit the present invention. An expression used in the singular encompasses the expression of the plural, unless it has a clearly different meaning in the context. In the present application, it is to be understood that the terms such as “including” or “having.” etc., are intended to indicate the existence of the features, numbers, steps, actions, components, parts, or combinations thereof disclosed in the specification, and are not intended to preclude the possibility that one or more other features, numbers, steps, actions, components, parts, or combinations thereof may exist or may be added.

What is claimed is:

1. A high temperature gas flow measuring device comprising:
a housing adapted to be connected with a pipeline of a flow system, said housing having an upstream end and a downstream end;
a means for measuring a differential pressure of a flow being mounted within said housing, and whereby said means for measuring results in a pressure drop of less than 1.5 inches water column; and
a means for cooling the temperature of said flow, said means for cooling being mounted to the exterior of said housing and whereby one end of said means for cooling is in communication with said means for measuring said differential pressure, and another end of said means for cooling is operably connected to a differential pressure instrument for indicating a flow rate of said flow.

2. The gas flow measuring device of claim 1, wherein said means for measuring a differential pressure comprises:
a total pressure sensing tube affixed within said housing traversing the interior cross sectional area of said flow measuring device for sensing the total pressure of said flow;
a static pressure sensing tube affixed within said housing traversing the interior cross sectional area of said flow measuring device for sensing the static pressure of said flow; and
said total pressure tube and said static pressure tube each having a first end in communication with the interior of said housing and a second end in communication with said means for cooling the temperature of said flow.

3. The gas flow measuring device of claim 1, wherein said means for measuring a differential pressure comprises:
a total pressure sensing tube affixed within said housing traversing the interior cross sectional area of said flow measuring device for sensing the total pressure of said flow, and said total pressure sensing tube having at least one sensing port penetrating said total pressure sensing tube, said sensing port positioned to face directly toward said flow for measuring total pressure;
a static pressure sensing tube affixed within said housing traversing the interior cross sectional area of said flow measuring device for sensing the static pressure of said flow, and said static pressure sensing tube having at least one sensing port penetrating said static pressure sensing tube, said sensing port positioned at a point of zero velocity for measuring static pressure; and
said total pressure tube and said static pressure tube each having a first end in communication with the interior of said housing and a second end in communication with said means for cooling the temperature of said flow.

4. The gas flow measuring device of claim 1, further including a flow straightener affixed within said housing and positioned adjacent said upstream end for reducing flow distortion.

5. The gas flow measuring device of claim 1, wherein said means for cooling the temperature of said flow comprises a first tube enclosed by a second tube, said second tube having a plurality of holes disposed around the circumference thereof for dissipating heat.

6. The gas flow measuring device further including at least one valve operably connected to the exterior of said device for controlling the gas flow.

7. The gas flow measuring device of claim 1, further including a manifold having at least one port for operably connecting said manifold to said differential pressure instrument, and at least one port for operably connecting said manifold to said means for cooling, and said manifold having at least one valve for controlling the gas flow.

8. A high temperature gas flow measuring device comprising:
a housing adapted to be connected with a pipeline of a flow system, said housing having an upstream end and a downstream end;
a means for measuring a differential pressure of a flow being mounted within said housing, and whereby said means comprises a total pressure sensing tube and a static pressure sensing tube affixed within said housing traversing the interior cross sectional area of said flow measuring device; and
a means for cooling the temperature of said flow, said means for cooling being mounted to the exterior of said housing and whereby one end of said means for cooling is in communication with said means for measuring said differential pressure, and another end of said means for cooling is operably connected to a differential pressure instrument for indicating a flow rate of said flow.

9. The gas flow measuring device of claim 8, wherein said total pressure sensing tube and said static pressure sensing tube are positioned according to Fechheimer Pitot standards for equal-area averaging;
said total pressure sensing tube having at least one sensing port penetrating said total pressure sensing tube, said sensing port positioned to face directly toward said flow for measuring total pressure; and
said static pressure sensing tube having at least one sensing port penetrating said static pressure sensing tube, said sensing port positioned at a point of zero velocity for measuring static pressure.

10. The gas flow measuring device of claim 8, further including a flow straightener affixed within said housing and positioned adjacent said upstream end for reducing flow distortion.

11. The gas flow measuring device of claim 8, wherein said means for cooling the temperature of said flow comprises a first tube enclosed by a second tube, said second tube having a plurality of holes disposed around the circumference thereof for dissipating heat.

12. The gas flow measuring device further including at least one valve operably connected to the exterior of said device for controlling the gas flow.

13. The gas flow measuring device of claim 8, further including a manifold having at least one port for operably connecting said manifold to said differential pressure instrument, and at least one port for operably connecting said manifold to said means for cooling, and said manifold having at least one valve for controlling the gas flow.

14. A high temperature gas flow measuring device comprising:
a housing adapted to be connected with a pipeline of a flow system, said housing having an upstream end and a downstream end;
a flow straightener affixed within said housing adjacent said upstream end;
a means for measuring a differential pressure of a flow being mounted within said housing, and whereby said means comprises a total pressure sensing tube and a static pressure sensing tube affixed within said housing traversing the interior cross sectional area of said flow measuring device;
a means for cooling the temperature of said flow, said means for cooling being mounted to the exterior of said housing and whereby one end of said means for cooling is in communication with said total pressure sensing tube and another end of said means for cooling is operably connected to a high pressure port;
a means for cooling the temperature of said flow, said means for cooling being mounted to the exterior of said housing and whereby one end of said means for cooling is in communication with said static pressure sensing tube and another end of said means for cooling is operably connected to a low pressure port;
said high pressure port and said low pressure port both being operably connected to a differential pressure instrument for indicating a flow rate of said flow; and
a first valve operably connected to said high pressure port for controlling the flow from said total pressure sensing tube;
a second valve operably connected to said low pressure port for controlling the flow from said static pressure sensing tube; and
a third valve operably connected to both said static pressure sensing tube and said total pressure sensing tube for controlling the flow from both said tubes simultaneously.
